(19) United States
(12) Patent Application Publication
(10) Pub. No.: US 2007/0132582 A1
(43) Pub. Date: Jun. 14, 2007

(54) Mobile object detection method and detection system

(75) Inventors: Ryosaku Kaji, Tokyo (JP); Hideo Itoh, Tokyo (JP)

Correspondence Address: WOLF GREENFIELD & SACKS, P.C., 600 ATLANTIC AVENUE, BOSTON, MA, 02210-2206, US

(73) Assignee: National Institute of Advanced Industrial Science and Technology, Tokyo (JP)

(21) Appl. No.: 11/636,940

(22) Filed: Dec. 11, 2006

(30) Foreign Application Priority Data
Dec. 13, 2005 (JP) 2005-358647

(51) Int. Cl. G08B 13/26

(52) U.S. Cl. 340/561

(57) ABSTRACT

The present invention provides a mobile object detection method, and a mobile object detection system, that allow detecting the movement of an object based on measurements of the electric field intensity generated by transmitters such as IC tags, while curbing implementation costs. Movement of the object is detected by measuring electric field intensity generated by a plurality of transmitters arranged in a detection space, obtaining a difference between the electric field intensity and an average value of the electric field intensity in a state where an object in the detection space is not moving, and detecting the movement of the object when the difference is equal to or larger than a threshold value based on a standard deviation of the electric field intensity in a state where the object in the detection space is not moving.

### CROSS REFERENCE TO RELATED APPLICATION

Foreign priority benefits are claimed under 35 U.S.C. §119(a)-(d) or 35 U.S.C. §365(b) of Japanese Application No. 2005-358647 filed Dec. 13, 2005, which is hereby incorporated by reference in its entirety.

### FIELD

The present invention relates to a mobile object detection method and detection system for detecting the movement of an object based on measurements of electric field intensity generated by a transmitter such as an IC tag.

### BACKGROUND

Recent years have witnessed a surge in research and development of applications based on short-range wireless communication technology using radio waves and/or light in, for instance, RFID (Radio Frequency Identification), in order to realize information services through position-based communications (see, for instance, Yoshiyuki Nakamura, Takuichi Nishimura, Hideo Itoh, and Hideyuki Nakashima, “ID-CoBIT: A Battery-less Information Terminal with Data Upload Capability”, Proc. of the 29^{th} Annual Conference of the IEEE Industrial Electronics Society (IECON), November 2003).

One of such applications is an information communication service using a card-sized communication terminal (see, for instance, National Institute of Advanced Industrial Science and Technology, Information Technology Research Institute, “Newsletter”, ITRI@EXPO 2005 AICHI JAPAN, March 2005)

This communication terminal incorporates an IR-based spatial optical communication system and an active-type wireless IC tag system. In the former is realized battery-less capture of voice information. In the latter, which involves a button battery-powered radio source, is realized people-flow analysis in exhibition grounds or the like.

### SUMMARY

When IC tags are used for grasping the movement of mobile bodies such as objects or people, however, if the frequency of the radio waves generated by the IC tags exceeds 30 MHz, the influence of local scattering in indoor measurements cannot be neglected, (Katsumi Furuya, Tomoteru Kawakami, Hiroyoshi Yajima, “Study of Microscopic Loop Antennas Measurement by a 3-Antenna Method”, IEEE Society of Instrumentation and Measurement, Japan Chapter, IM-01-3, pp. 13-17, February 2001), and it becomes thus difficult to estimate the position of the radio source using a purely far field-based methodology.

That is, in light of the frequency bands of about 300 MHz widely used at present, grasping position information in a closed space based on an IC tag system alone requires solving the inverse problem of estimating radio sources on the basis of electric field intensity and/or phase as measured by receivers (Yoshio Okamoto, “Inverse Problems and Solution Methods”, Ohmsha Ltd., 1992).

Solving such a problem, however, is extremely difficult, while calculating position information in real time by introducing a process in which the Maxwell equations are solved on the basis of boundary conditions that take into account local structures is considered to be virtually impossible.

For this reason, grasping in real time position information based on an IC tag system alone in indoor facilities such as event halls, department stores or the like, in which there is a substantial demand for information services, entailed hitherto substantially higher costs for implementing a detection environment, for instance through the arrangement of receiving antennas in a number proportional to position density, and through detection and estimation of entering and leaving in/from reception areas by mobile objects of which IC tags are accessory.

For instance, when it comes to monitoring space disturbances in areas and/or times in which no mobile objects must be present, mainly in security services, judging whether there are any mobile objects present or not is more important than grasping the movement of the mobile objects. There are methods for achieving this goal with plural receivers arranged as described above wherein, in addition to high implementation costs, it may not be possible to attach an IC tag to a mobile object. Specific examples include, for instance, detection of intruders after office hours in companies, department stores, vaults, storage facilities, military weapon depots, or in private residences when no one is home or in the deep night hours.

In light of the foregoing, it is an object of the invention of the present application to provide a mobile object detection method, and a mobile object detection system, that allow detecting the movement of an object based on measurements of the electric field intensity generated by transmitters such as IC tags, while curbing implementation costs.

In order to solve the above problems, firstly, the mobile object detection method of the invention of the present application comprises the steps of measuring electric field intensity generated by a plurality of transmitters arranged in a detection space; obtaining a difference between the electric field intensity and an average value of the electric field intensity in a state where an object in the detection space is not moving; and detecting the movement of the object when the difference is equal to or larger than a threshold value based on a standard deviation of the electric field intensity in a state where the object in the detection space is not moving.

Also, the mobile object detection system of the invention of the present application comprises means for measuring electric field intensity generated by a plurality of transmitters arranged in a detection space; and means for obtaining a difference between the electric field intensity and an average value of the electric field intensity in a state where an object in the detection space is not moving, and detecting the movement of the object when the difference is equal to or larger than a threshold value based on a standard deviation of the electric field intensity in a state where the object in the detection space is not moving.

In accordance with the first and second inventions of the present application, mobile object detection can be realized while curbing implementation costs by fixedly arranging beforehand in a detection space transmitters such as active-type wireless IC tags for sending signals, as a radio wave medium, without the transmitters being attached to the mobile object, the electric field intensity generated by the respective transmitters being measured by one or relatively few receivers such as tag readers, fixedly arranged separately in the detection space, and by, for instance, centrally managing electric field intensity data with a computer, sequentially calculating an average value and a standard deviation of electric field intensity within a prescribed lapse of time when no object is moving, observing electric field intensity changes when the object moves, and noting divergences from the average value equal to or larger than a threshold value based on the standard deviation.

Mobile object detection can be realized, thus, simply by monitoring the average value and standard deviation of the electric field intensity generated by a plurality of transmitters arranged at intervals, even in environments such as in rooms or in corridors where, on account of multiple reflection and/or interference, the electric field intensity formulae based on far-field are ineffective and estimation of transmitter positions is not possible. That is, movement of an object can be detected, even in closed spaces where any obstacle may be present, by arranging transmitters at locations that allow the receivers to measure electric field intensity on a regular basis.

The invention of the present application can be suitably used for a wide variety of applications, obviously in position-based information services, but also in the field of security services, being effective in all manner of services relating to monitoring of space disturbances in areas and/or times in which no mobile objects must be present. Specifically, the invention can be suitably used for implementing inexpensive detection of intruders after office hours in companies, department stores, vaults, storage facilities, military weapon depots, or in privates residences when no one is home or in the deep night hours, detection of piping anomalies in nuclear facilities or the like, or detection of abnormal situations in underground passages or tunnels.

### DESCRIPTION OF DRAWINGS

FIG. 1 is a diagram explaining the invention of the present application;

FIG. 2 is a diagram illustrating a measurement example of electric field intensity in the situation of FIG. 1;

FIG. 3 is a diagram explaining the invention of the present application;

FIG. 4 is a diagram illustrating a measurement example of electric field intensity in the situation of FIG. 3;

FIG. 5 is a diagram illustrating an example of the invention of the present application;

FIGS. 6A and 6B are diagrams illustrating an example of the invention of the present application;

FIGS. 7A and 7B are diagrams illustrating an example of the invention of the present application;

FIGS. 8A and 8B are diagrams illustrating an example of the invention of the present application; and

FIG. 9 is a diagram illustrating an example of the invention of the present application.

### DETAILED DESCRIPTION

Firstly, a plurality of transmitters are fixedly arranged at equidistant intervals such that, as explained next, the temporal change of electric field intensity when an object is moving is large enough to be sufficiently distinguished from the temporal change of electric field intensity when the object is not moving.

In situations where local scattering can be neglected, electric field intensity measured by a receiver is given by the far field-based formula below when the distance between a transmitter such as an active-type IC tag and a receiver such as a tag reader is sufficiently larger than the wavelength (Saburo Adachi, “Electromagnetic Wave Engineering”, Corona Publishing Co. Ltd., p. 39, 1983)

$$E ( r ) = \frac{{C}_{0}}{R} \qquad Formula 1$$

In the formula, E represents the electric field intensity, R the distance between transmitter and receiver, and C₀ a constant related to transmission power and reception efficiency.

When local scattering cannot be neglected, the Maxwell equations must be solved on the basis of boundary conditions that take into account local structures, in order to obtain an expression corresponding to Formula 1 that links electric field intensity and distance.

When the wave source is moving, however, such a relational expression changes over time, and hence although a method could be devised for solving the Maxwell equations sequentially, comparing the measured electrical fields, and estimating the position of the wave source, solving in real time such a problem for a closed space lacking structural symmetry would be extremely difficult at present for the capabilities of ordinary computers.

In the invention of the present application, therefore, in order to detect the movement of an object without solving sequentially the Maxwell equations, the average value and standard deviation of electric field intensity when the object is not moving are monitored; the change in electric field intensity when the object moves is observed; deviances equal to or larger than a threshold value based on the standard deviation is noted; and, hence, the movement of the object is detected.

In environments with large local scattering, plural transmitters n (=1, . . . , N) are fixedly arranged spaced from one another, and their respective electric field intensity is continually measured by receivers. If the energy supplied by the transmitters is constant, the time-series data of the electric field intensity measured by the respective receivers, in the absence of disturbances such as the movement of an object, exhibit a distribution similar to a normal distribution centered around the average value E_{average} of the time series data of the nearest past m time series data, without deviating substantially from E_{average}. A normal distribution refers herein to a distribution in which 99.7% of all data fall within the average±3 standard deviations, for instance, taking ΔE (=threshold value) as 10 times the standard deviation, virtually 100% of the electric field intensities En of the transmitters n measured by the receivers falls within the range below.
E_{average}−ΔE<Eₙ<E_{average}+ΔE Formula 2

The nearest past m time series data are the number of data acquired over a period of time sufficiently longer than the time elapsed from the moment the object switches from a moving state to a stationary state until the value of the electric field intensity becomes substantially constant. In the case of a pedestrian as the mobile object, the field becomes substantially constant in a matter of several seconds, and hence m becomes about 100 (corresponding to 5 seconds) if the signal emission frequency of the transmitters is set to, for instance, 0.05 seconds.

The “standard deviation” is a value obtained by taking the square root of the average of the squares of the differences between the average value E_{average} and the respective measured values.

When in such an environment the object is large compared to the wavelength size of the radio waves of the transmitters, the movement of the object affects the electric field intensity, which thereupon deviates widely from the reference value E_{average}. The movement of the object is detected based on the extent of such deviation. That is, the object is judged to be moving if the difference between a measured value Eₙ and the average value E_{average} is sufficiently larger than, for instance, ΔE, which is 10 times the standard deviation (i.e., if the inequality of formula 2 is not satisfied).

Although the threshold value ΔE was taken as 10 times the standard deviation in the above explanation, the threshold value ΔE is not particularly limited thereto, and may be arbitrarily set so as to afford a sufficiently precise detection in accordance with factors such as the shape and size of the detection space, the type of transmitters and receivers, and the arrangement relationship thereof.

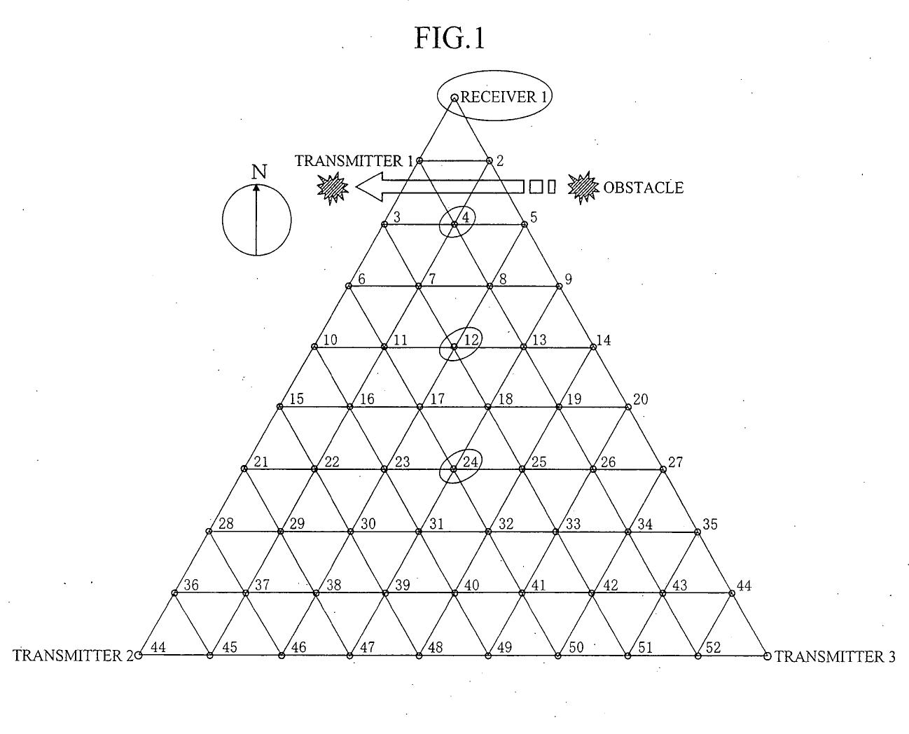

The above detection method is explained in detail on the basis of concrete embodiments illustrated in FIGS. 1 through 4.

Firstly, transmitters 1 to 52 are fixedly arranged at equidistant intervals within a triangular planar area such as the one illustrated in FIG. 1, while receivers 1 to 3 are arranged fixedly at the vertices of the triangular area surrounding the transmitters 1 to 52; and, the receivers 1 to 3 are continually measuring the electric field intensity generated by the transmitters 1 to 52.

An obstacle crosses then the north side of the triangular area (between the line joining the transmitters 1 and 2 and the line joining the transmitters 3, 4 and 5), as illustrated in FIG. 1.

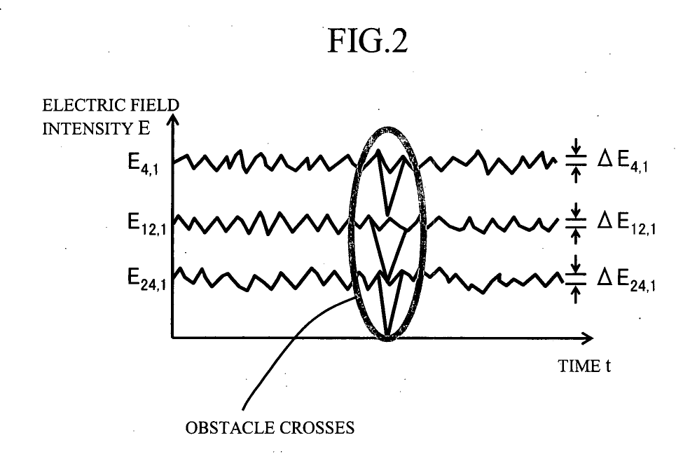

In such a case, the radio waves for the electric field intensity of a transmitter n (=1,2) measured by the receiver 1 are not blocked when the obstacle is crossing, and hence the electric field intensity keeps within a range smaller than a change to the extent of ΔE_{n,1} based on the standard deviation. By contrast, the radio waves for the electric field intensity of a transmitter n (=3, 4, 5, . . . , 52) measured by the receiver 1 are blocked when the obstacle is crossing, and hence the electric field intensity exhibits a change that deviates from ΔE_{n,1}. As illustrated in FIG. 2, specifically, the electric field intensity E_{4,1} of the transmitter 4, the electric field intensity E_{12,1} of the transmitter 12, and the electric field intensity E_{24,1} of the transmitter 24, exhibit only fluctuation changes when the obstacle is not crossing, and the relationship of the above Formula 2 holds; at the moment in which the obstacle is crossing, however, the electric field intensities change beyond fluctuations and acquire values largely diverging from the respective standard deviations ΔE_{4,1}, ΔE_{12,1} and ΔE_{24,1}. That is because the radio waves that ought to reach the receiver 1 are blocked by the obstacle, which causes the measured value of the electric field intensity to drop steeply.

Meanwhile, the electric field intensity E_{n,2} of a transmitter n (=1,2) measured by the receiver 2 exhibits similarly a change equal to or larger than ΔE_{n,2}, while the electric field intensity E_{n,2} of a transmitter n (=3, 4, 5, . . . , 52) does not exhibit a change equal to or larger than ΔE_{n,2}, since the obstacle does not block the radio waves between the transmitters and the receiver. The same applies to the receiver 3.

The time series data of the electric field intensities of the transmitters n (1, 2, . . . , 52) acquired by the plural receivers 1 to 3 are processed by a network, a computer or the like, to allow identifying the transmitters entering a blind spot due to the obstacle, and to grasp the travel made by the obstacle, or whether the obstacle is moving.

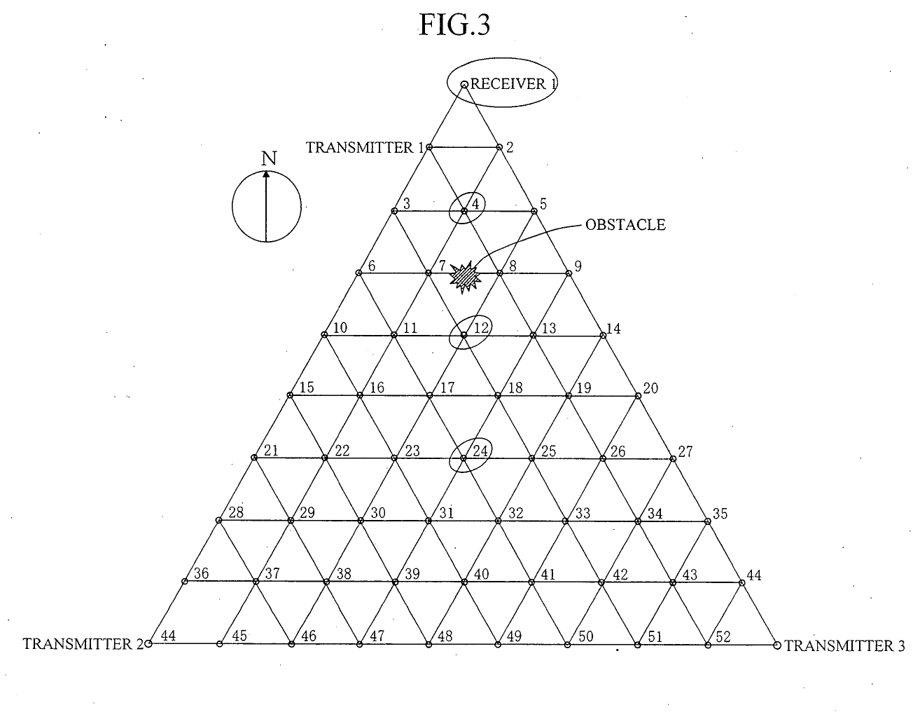

Next, an obstacle falls hypothetically on a point in the middle of a line joining the transmitters 6, 7, 8 and 9 within the planar area, as exemplified in FIG. 3.

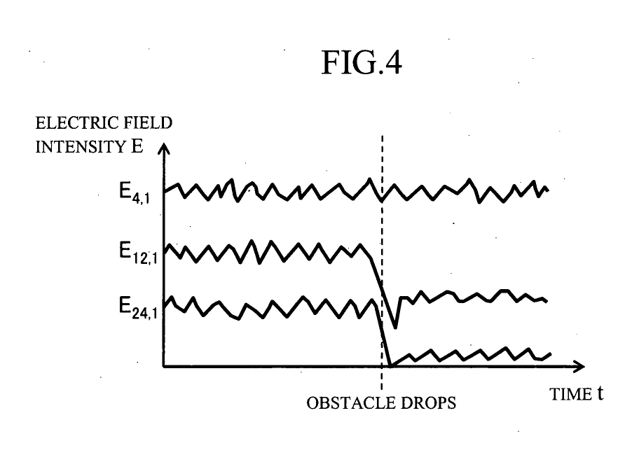

In such a case, when the radio waves for the electric field intensity of a transmitter n (=1 to 52) measured by the receiver 1 are not blocked by the obstacle, the electric field intensity keeps within a range smaller than a change to the extent of the value ΔE_{n,1} based on the standard deviation, while when the radio waves are blocked by the obstacle, the electric field intensity exhibits a change that deviates from ΔE_{n,1}. As illustrated in FIG. 4, specifically, the various electric field intensities E_{4,1}, E_{12,1} and E_{24,1} exhibit only fluctuation changes when the obstacle has not fallen yet, and the relationship of the above Formula 2 holds; at the moment in which the obstacle falls, however, the radio waves become partially blocked, and thenceforth the electric field intensities E_{12,1} and E_{24,1} acquire values largely diverging from the respective standard deviations ΔE_{12,1} and ΔE_{24,1} Over time, a new constant value sets in, and fluctuations become again approximately equivalent to the standard deviation.

In the receiver 2, meanwhile, the obstacle blocks radio waves only for the electric field intensity E_{5,2} of a transmitter (for instance, n=5), whereby the electric field intensity E_{5,2} drops deviating from ΔE_{5,2}, while in the receiver 3 the obstacle blocks radio waves only for the electric field intensity E_{3,3} of a transmitter (for instance, n=3), whereby the electric field intensity E_{3,3} drops deviating from ΔE_{3,3}.

The time series data of the electric field intensity acquired by the receivers 1 to 3 are comprehensively processed by a network or the like, to allow identifying the transmitters entering a blind spot due to the obstacle, and to estimate the time at which the object fell and the spot on which it fell.

### EXAMPLE 1

1. Experiment for Measuring Electric Field Intensity

An experiment carried out to measure actual electric field intensities is explained below.

The equipment used in the experiment, comprising:

Receiver, Tag reader LAS300R (from K-ubique ID Co.); and

Transmitters, Active RFID tag LA300T1 (from K-ubique ID Co.).

The measurement results were analyzed employing an analysis program created using Lab VIEW (from National Instruments); this program was installed in a computer in which was executed the analysis process for the input measured values of the tag reader.

The radio waves of the tags had a frequency of 315 MHz, a wavelength of about 1 m, and the experimental environment was a frequency area in which local scattering could not be neglected (see Katsumi Furuya, Tomoteru Kawakami, Hiroyoshi Yajima, “Study of Microscopic Loop Antennas Measurement by a 3-Antenna Method”, IEEE Society of Instrumentation and Measurement, Japan Chapter, IM-01-3, pp. 13-17, February 2001).

To build the detection system of the invention of the present application are used, for instance, means for detecting electric field intensity, and, as mobile object detection means, a receptor such as a tag reader mapped to a transmitter, and an analysis program and/or a device such as a computer in which is installed such a program, in which case the analysis program has a function not only for analyzing the average value and standard deviation of electric field intensities but also a detection program function for monitoring such average values and standard deviations and for determining threshold values.

2. Electric Field Intensity Dependence on Transmitter-Receiver Distance

In order to study first whether far-field conditions indicated by Formula 1 apply effectively indoors, a tag reader was installed and a tag was positioned at a distance r from the tag reader, then the electric field intensity was measured.

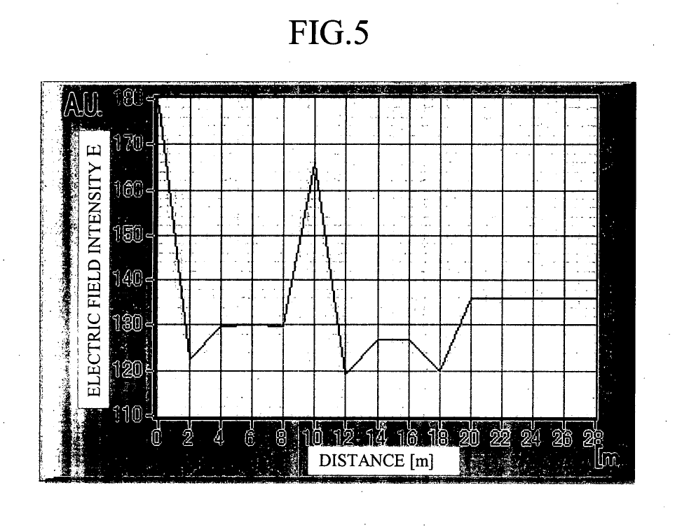

FIG. 5 illustrates the distance dependence of electric field intensity measured by the tag reader in a corridor (width 2.4 m, height 2.7 m) with no people traffic. The x-axis represents the distance r (m) between tag and reader, and the y-axis represents the electric field intensity E (arbitrary units). As FIG. 5 shows, the distance dependence of electric field intensity does not conform to Formula 1, which means that local influences cannot be neglected.

3. Mobile Object Detection Based on Divergence of the Electric Field Intensity Average Value from the Standard Deviation

Mobile object detection is explained next.

3.1 In Absence of Object Movement (=Steady State)

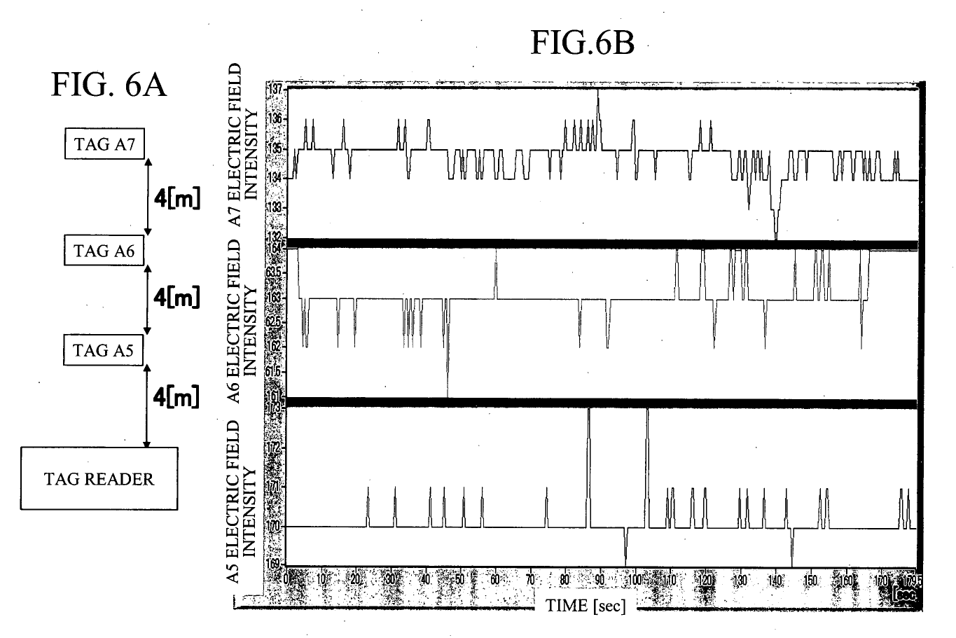

Firstly, as illustrated in FIG. 6A, a reader was installed and three tags A5, A6 and A7 were arranged consecutively away from the reader at intervals of 4 m, then electric field intensity was measured in a state of no object movement. The tag reader, tags, analysis (detection) program were identical to those described above.

FIG. 6B illustrates the temporal change of electric field intensity. The x-axis represents herein time (seconds) and the y-axis represents the electric field intensity E of the tags A5, A6 and A7, sequentially from the bottom, in arbitrary units. The average value and the standard deviation of the electric field intensities of the tags A5, A6 and A7 are given in Table 1.

TABLE 1

| | Electric field | |
|---|---|---|
| | intensity average value | Standard deviation |
| Tag number | E_{average} [A.U.] | ΔE |
| A5 | 170.1 | 0.379 |
| A6 | 163.1 | 0.431 |
| A7 | 134.8 | 0.586 |

As Table 1 shows, the temporal change of electric field intensity, in a steady state with no object movement, involves a standard deviation of 0.5% or less in environments in which local scattering cannot be neglected. This tendency is independent from the distance between tag and reader (between transmitter and receiver).

3.2 Upon Object Movement

Mobile object detection is approached on the basis of the above facts.

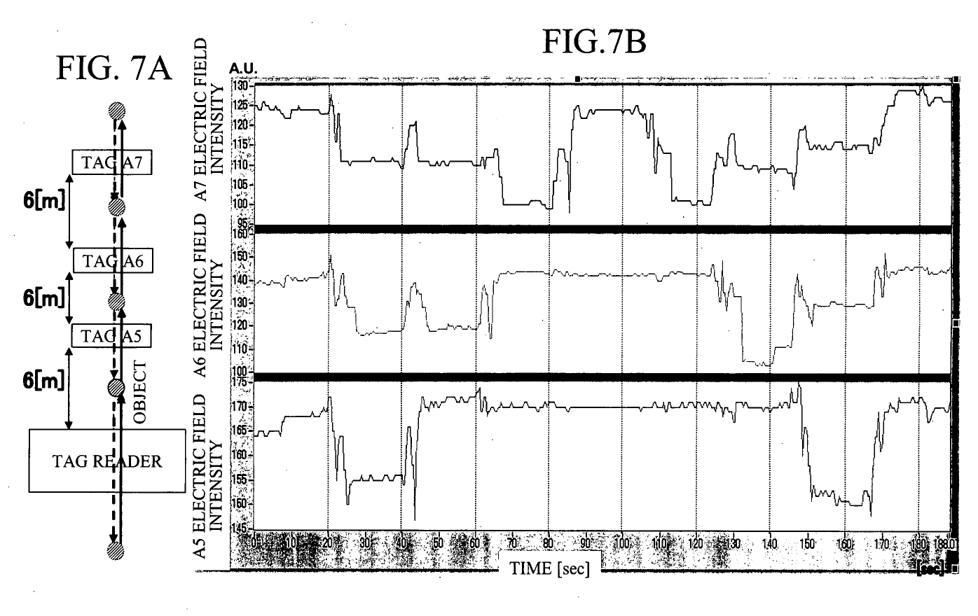

As illustrated in FIG. 7A, a reader was installed and three tags A5, A6 and A7 were arranged consecutively away from the reader at intervals of 6 m, then an object having a size similar to the wavelength of the tags, of about 1 m, moved in a straight line for several seconds, following the path below, at intervals of 20 seconds. The tag reader, tags, analysis (detection) program were identical to those described above.

(Rear of the tag reader)→(between tag reader and A5)→(between A5 and A6)→(between A6 and A7) →(ahead of A7)→(between A7 and A6)→(between A6 and A5) →(between A5 and tag reader) →(rear of the tag reader).

FIG. 7B illustrates the temporal change of electric field intensity. The x-axis represents herein time (seconds) and the y-axis represents the electric field intensity E of the tags A5, A6 and A7, sequentially from the bottom, in arbitrary units. As FIG. 7B shows, the electric field intensity change at the 20 second intervals, when the object moves, deviates from the steady state average value E_{average} by more than ΔE, which is 10 times the standard deviation.

In a more detailed analysis, the object starts moving at the 20 second mark in FIG. 7B, passes the tag reader, and stops between the tag reader and the tag A5. At this time, the average value E_{average} of the electric field intensity drops for all the tags A5, A6 and A7, by more than ΔE, which is 10 times the standard deviation in the steady state. This drop results from blocking of the radio waves of the tags A5, A6 and A7 by the object.

At the 40 second mark, the object passes the tag A5 and stops between the tag A5 and the tag A6. At this time, the average value E_{average} of the electric field intensity of the tag A5 rises by more than ΔE, which is 10 times the standard deviation, but the average value E_{average} of the tags A6 and A7 does not change by that much. This indicates that the object does not block now radio waves between the tag reader and the tag A5.

At the 60 second mark, the object passes the tag A6 and stops between the tag A6 and the tag A7. At this time, the average value E_{average} of the electric field intensity of the tag A6 rises by more than ΔE, which is 10 times the standard deviation. This indicates that the object does not block now radio waves between the tag reader and the tag A6.

At the 80 second mark, the object passes the tag A7 and stops ahead of the tag A7. At this time, the average value E_{average} of the electric field intensity of the tag A7 rises by more than ΔE, which is 10 times the standard deviation. This indicates that the object does not block now radio waves between the tag reader and the tag A7.

At the 100 second mark, the object turns around from its position ahead of the tag A7 and stops between the tag A7 and the tag A6. At this time, the average value E_{average} of the electric field intensity of the tag A7 drops by more than ΔE, which is 10 times the standard deviation. This indicates that the object blocks again radio waves between the tag reader and the tag A7.

The change in electric field intensity on account of object movement every 20 seconds thereafter can be explained as above.

From the foregoing it follows that the movement of an object can be detected by monitoring the average value E_{average} and standard deviation ΔE/10 of the electric field intensity in the absence of object movement, and by noting divergences from the average value E_{average} by ΔE or more.

Such movement detection is effective for detecting abnormal situations in closed spaces that are ordinarily unmanned in, for instance, department stores, vaults or the like after office hours, or in nuclear facilities and the like.

### EXAMPLE 2

Detection of Door Opening/Closing

Herein was detected the opening and closing of a door and the entry and exit of a mobile object into and out of a room, to confirm the feasibility of abnormal-state detection. The tag reader, tags and the analysis (detection) program were the same as above.

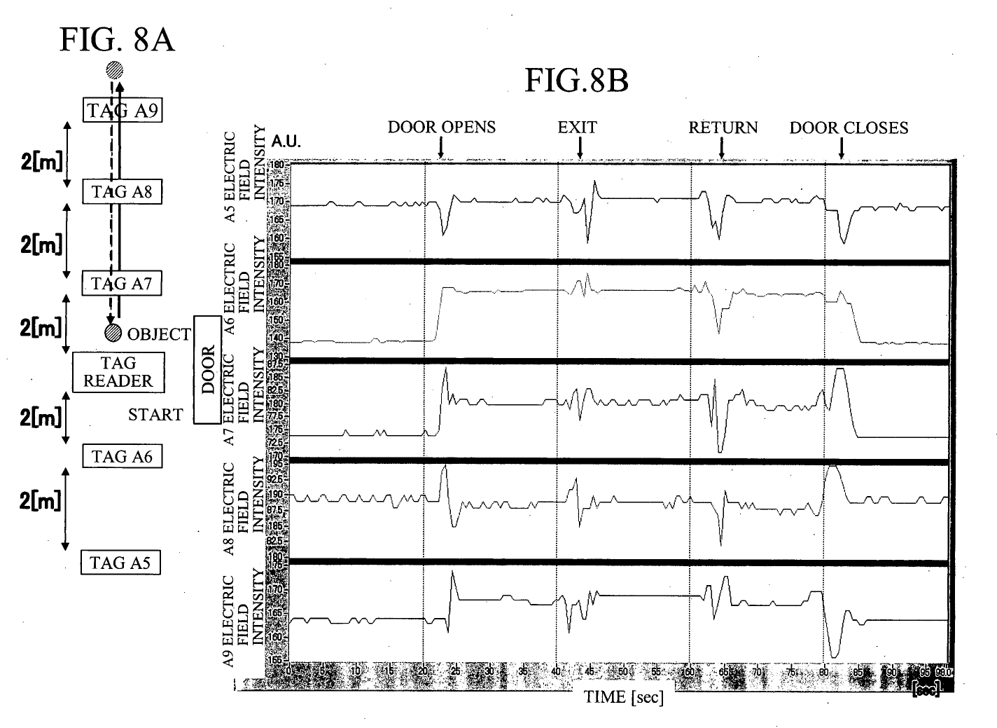

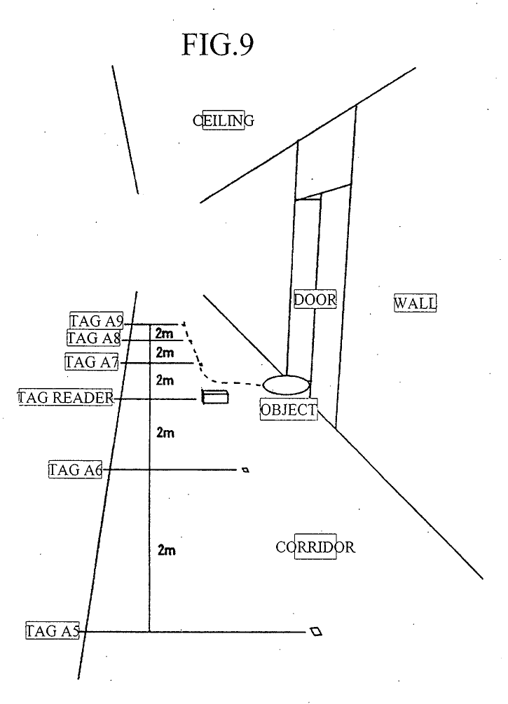

As illustrated in FIGS. 8A and 9, a tag reader was installed in a corridor in front of a door, and tags were arranged in the corridor at intervals of 2 m. The door was opened 20 seconds after the start of the experiment (“start” in the figure); 40 seconds after experiment start an object came out of a room and passed the tags A7 to A9; 60 seconds after experiment start the object passed again the tags A7 to A9 and entered into the room; and 80 seconds after experiment start the door was closed.

FIG. 8B illustrates temporal changes of electric field intensity, in which the electric field intensity E of the tags A5 to A9 is represented sequentially from the top in arbitrary units. The x-axis represents herein time (seconds) and the y-axis represents the electric field intensity E.

As FIG. 8B shows, large electric field intensity changes occur in the vicinity of the time marks when the object moves every 20 seconds. These changes, which largely exceed the ΔE value that is 10 times the standard deviation of the ordinary electric field intensity, are the basis of the mobile object detection method. Also, the door remains open between the 20 second mark and the 80 second mark, during which the time average value E_{average} of the electric field intensity of the tags A6 and A7 close to the tag reader rises considerably above that of other tags. This allows assessing the open state of the door.

As made clear by way of the above examples, the method for detecting the movement of an object according to the invention of the present application allows detecting the movement and the position of a mobile object to be detected by measuring the electric field intensity generated by transmitters, even when no transmitter is attached to the mobile object.

In environments where it is not possible to estimate transmitter position on a far-field basis, the movement of an object can also be detected by fixedly arranging transmitters at equidistant intervals, measuring the respective electric field intensities and sequentially calculating the average value and the standard deviation of electric field intensity within a prescribed lapse of time, observing electric field intensity changes when the object moves, and noting such divergences from the average value that are equal to or larger than a threshold value based on the standard deviation.

The arrangement relationship among the transmitters and the receivers is not particularly limited, and for instance the arrangements exemplified in FIGS. 1 and 3, and/or the arrangements described in the above examples can be arbitrarily designed in accordance with the actual environment, provided that the arrangement relationship allows the receivers to measure on a regular basis the electric field intensity generated by the transmitters.

As described above, the invention of the present application can be suitably used for a wide variety of applications not only in position-based information services but also in the field of security services, being effective in all manner of services relating to monitoring of space disturbances in areas and/or times in which no mobile objects must be present. Specifically, the invention can find suitable application, among others, in the detection of intruders after office hours in companies, department stores, vaults, storage facilities, military weapon depots, or in privates residences when no one is home or in the deep night hours, detection of piping anomalies in nuclear facilities or the like, or detection of abnormal situations in underground passages or tunnels. Moreover, these service systems can be built inexpensively.

We Claim:

1. A mobile object detection method, comprising:
measuring electric field intensity generated by a plurality of transmitters arranged in a detection space;
obtaining a difference between the electric field intensity and an average value of the electric field intensity in a state where an object in the detection space is not moving; and
detecting the movement of the object when the difference is equal to or larger than a threshold value based on a standard deviation of the electric field intensity in a state where the object in the detection space is not moving.

2. A mobile object detection system, comprising:
means for measuring electric field intensity generated by a plurality of transmitters arranged in a detection space; and
means for obtaining a difference between the electric field intensity and an average value of the electric field intensity in a state where an object in the detection space is not moving, and detecting the movement of the object when the difference is equal to or larger than a threshold value based on a standard deviation of the electric field intensity in a state where the object in the detection space is not moving.
